(19) United States
(12) Patent Application Publication
(10) Pub. No.: US 2026/0360172 A1
(43) Pub. Date: Nov. 12, 2026

(54) RECOGNIZING TEXT FROM IMAGE DATA USING DEEP LEARNING TEXT DETECTION AND RECOGNITION MODELS

(71) Applicant: Walmart Apollo, LLC, Bentonville, AR (US)

(72) Inventors: Raghava Balusu, Achanta (IN); Zhaoliang Duan, Frisco, TX (US); Lingfeng Zhang, Flower Mound, TX (US); Mingquan Yuan, Flower Mound, TX (US); Yilun Chen, McKinney, TX (US); Ashlin Ghosh, Ernakulam (IN); Abhinav Pachauri, Bangalore (IN); Avinash M. Jade, Bangalore (IN); Eric W. Rader, Plano, TX (US); William Craig Robinson, Centerton, AR (US)

(21) Appl. No.: 19/204,188

(22) Filed: May 9, 2025

(51) Int. Cl. G06V 30/19; B25J 19/02; G06T 3/40; G06V 30/18

(52) U.S. Cl. CPC G06V 30/19147; B25J 19/023; G06T 3/40; G06V 30/18057

(57) ABSTRACT

Examples provide improved image recognition as a service (IRAS) price tag optical character recognition (OCR) using augmented training data for accurate text detection and recognition. Image data is obtained which includes images of text associated with price tags on item storage structures. The images are augmented using a set of transformations to create one or more image quality issues associated with one or more features of the images to decrease readability of the text by the models. For example, affine transformations can be performed to blur images, darken images, rotate or angle text, etc. The augmented images are used to create augmented training data for training deep learning OCR models to accurately detect and recognize text appearing in images having quality issues and/or images having text associated with a plurality of different tag types and a plurality of different tag types and a plurality of different typefaces.

### BACKGROUND

Computer vision (CV) image recognition as a service (IRAS) can be used to automatically identify objects of interest appearing in images of the objects with little or no human intervention. However, these models frequently struggle to accurately detect and recognize text appearing in images due to the complex and frequently unpredictable and inconsistent appearance of text in images. For example, text can appear in a variety of formats, font types, font sizes, colors, layouts, etc. Moreover, text can frequently be obscured by handwritten markings or contain other inconsistencies which makes OCR text extraction costly, unreliable and error prone.

### SUMMARY

The scope of this disclosure includes various systems and methods for creating augmented training data for training deep learning models to detect and recognize text on a variety of different types of tags appearing in images with greater accuracy and reliability. Some examples provide an image augmentation manager which obtains a plurality of images of a tag associated with a portion of an item storage structure from one or more image capture devices. Image augmentation is performed on each image in the plurality of images to reduce readability of text by an optical character recognition (OCR) deep learning (ML) model. The image augmentation includes changing at least one feature of each image. Reducing readability refers to altering the at least one feature to increase a degree of difficulty associated with detecting and recognizing text in an image by deep learning models. The image augmentation manager creates augmented training data using the augmented images. The augmented images include images of a plurality of different tag types and/or a plurality of different typefaces. A set of deep learning OCR models is trained using the augmented training data. The set of deep learning OCR models includes a text detection model for detecting text associated with the plurality of different tag types within an image and a text recognition model recognizing text appearing in the plurality of different typefaces within the image. The trained set of deep learning OCR models are used to identify text appearing in reduced quality images in real-time with greater accuracy.

### BRIEF DESCRIPTION OF THE DRAWINGS

FIG. 1 is an exemplary block diagram illustrating a system for training deep learning optical character recognition (OCR) models using augmented training data for improved text detection and recognition.

FIG. 2 is an exemplary block diagram illustrating a retail facility including a plurality of image capture devices associated with one or more mobile robotic devices for generating images of tags.

FIG. 3 is an exemplary block diagram illustrating an image augmentation manager for generating augmented training data and training deep learning OCR models.

FIG. 4 is an exemplary flow chart illustrating operation of the computing device to train deep learning OCR models for detection and recognition of text where image quality is suboptimal.

FIG. 5 is an exemplary flow chart illustrating operation of the computing device to detect and recognize text associated with a variety of tag types and typefaces.

FIG. 6 is an exemplary flow chart illustrating operation of the computing device to obtain and annotate image data for use in training data.

FIG. 7 is an exemplary flow chart illustrating operation of the computing device to perform image transformations creating image quality issues associated with one or more features of an image.

FIG. 8 is an exemplary diagram illustrating an image of a tag on a portion of an item storage structure.

FIG. 9 is an exemplary diagram illustrating a tag having item-related data in a text format.

FIG. 10 is an exemplary diagram illustrating a plurality of different types of tags having a plurality of different typefaces.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Price tags on product shelving and pallet storage structures can play an important role in recognizing pallets of items as well as individual items in inventory by extracting textual information from visible tags, enabling the pairing of price tag text with item detection. However, the inconsistencies and lack of standardization across tags used in a retail facility makes it difficult for computer vision (CV) image recognition as a service (IRAS) models to identify and read text on these non-standard tags. Moreover, general purpose OCR solutions can be costly and typically cannot provide high accuracy text recognition results as they are trained on diverse, general-purpose text recognition tasks, cannot be optimized for the unique characteristics of price tags, and may not have sufficient exposure to the specific challenges that come with price tags. Price tags often have a specific font, layout, and design, and may include various noise factors like background patterns, special characters, and inconsistent lighting conditions.

Thus, current solutions are frequently unreliable in producing consistent results due to inability of these systems to read text in different types of tags having different fonts and layouts as well as failure to accurately read tags in edge cases where image quality is sub-optimal. Sub-optimal image quality occurs where there is a quality issue associated with one or more features of the image, such as, but not limited to, low resolution, poor lighting, incorrect camera angle, obstructions blocking text, blurring, etc. In these situations, it becomes very difficult if not impossible to accurately extract this information from images using typical general purpose OCR models. Thus, these systems can be unreliable and error prone as well as frequently incurring significant costs for merchants.

Referring to the figures, examples of the disclosure enable augmented training of deep learning OCR models in which models are trained on a carefully curated dataset containing challenging cases, such as blurry, poorly lit, angled, or low-resolution images, to detect the text regions from price-tags and then recognize the text information. The training data is generated by augmenting high quality, annotated image data associated with images of a wide variety of different type of tags having a plurality of text layouts and typefaces for printed text and digital text. This augmented training enables the trained deep learning OCR models to accurately and reliably detect and recognize text in a wide range of different tag types appearing in images having a broad range of image quality, including edge cases with poor lighting, blurred images, glare, obscured text, text appearing at suboptimal angles in images, etc. This enables augmented text detection and recognition with a reduced error rate in OCR text extraction with more consistent and reliable results.

The computing device operates in an unconventional manner by modifying high quality images of a plurality of different tag types to produce annotated training images containing quality issues associated with one or more features of the images for improved training of models and production of more accurate and reliable OCR text detection and recognition by the trained models. This reduces costs by enabling the system to more accurately read text appearing in all the different types of tags in a retail environment using a single set of trained models which can be trained using a single training data set representing every type of tag in current use. It further reduces costs by reducing errors in text detection and recognition which further reduces human labor and time required to identify and correct errors. In this manner, the computing device is used in an unconventional way, and allows text detection and recognition with increased reliability, decreased costs, and reduced error rate in detection and recognition results, thereby improving the functioning of the underlying computing device.

The augmented training data generated by the system further increases speed of training the deep learning OCR models by enabling training using a single training data set including annotated images covering all types of tags and every type of quality issue which may occur in an image payload generated by the image capture devices in the retail facility.

The system reduces resource usage, such as memory, processor and network bandwidth usage consumed during training and/or error handling. For example, the system conserves memory by reducing the number of training data sets required for training which are stored in memory. The system reduces processor load by training the models using a single augmented training data set rather than multiple training data sets and/or multiple training epochs. It further reduces processor and network bandwidth usage which would otherwise be consumed flagging unreadable text in images for human review, such as in manual error handling.

In other embodiments, the results of the deep learning OCR models are presented to a user via a UI. This enables improved user efficiency via UI interaction and increased user interaction performance. The reduced error rate in text detection and recognition results further improves the accuracy and reliability of results presented to the user for review via the UI, further improving user performance while reducing user time and costs associated with error handling.

In other embodiments, the system accurately extracts text information from a wide variety of price tag types found in stores. A pipeline downloads images from a robotic device (scrubber robot), categorize them based on OCR text from price tags, and create a stratified sample dataset annotated with price tag bounding boxes, text regions, and text using an image annotation platform. The models are custom-trained explicitly for predicting text from price tags. This specialization improves the specificity of predictions, leading to more accurate and reliable results tailored to the unique characteristics of price tags in stores. The rigorous training and optimization enables the deep learning OCR models achieve improved accuracy in text extraction from price tags. This high accuracy not only ensures the reliability of the extracted information but also contributes to improved efficiency and effectiveness in various applications such as inventory management and automatic labeling.

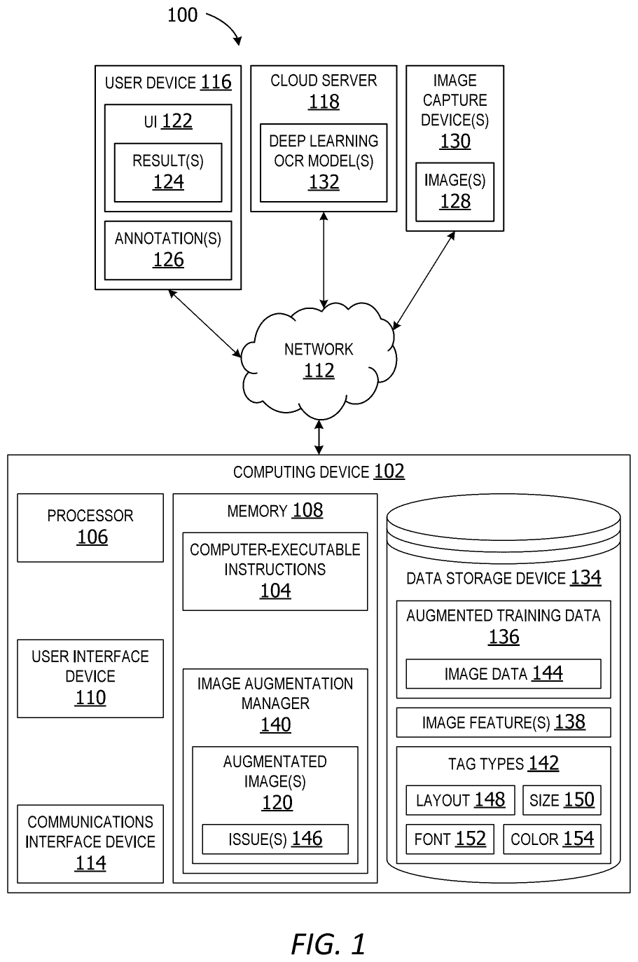

Referring again to FIG. 1, an exemplary block diagram illustrates a system 100 for training deep learning optical character recognition (OCR) models using augmented training data for improved text detection and recognition. In the example of FIG. 1, the computing device 102 represents any device executing computer-executable instructions 104 (e.g., as application programs, operating system functionality, or both) to implement the operations and functionality associated with the computing device 102. The computing device 102, in some examples includes a mobile computing device or any other portable device. A mobile computing device includes, for example but without limitation, a mobile telephone, laptop, tablet, computing pad, netbook, gaming device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples includes a user interface device 110.

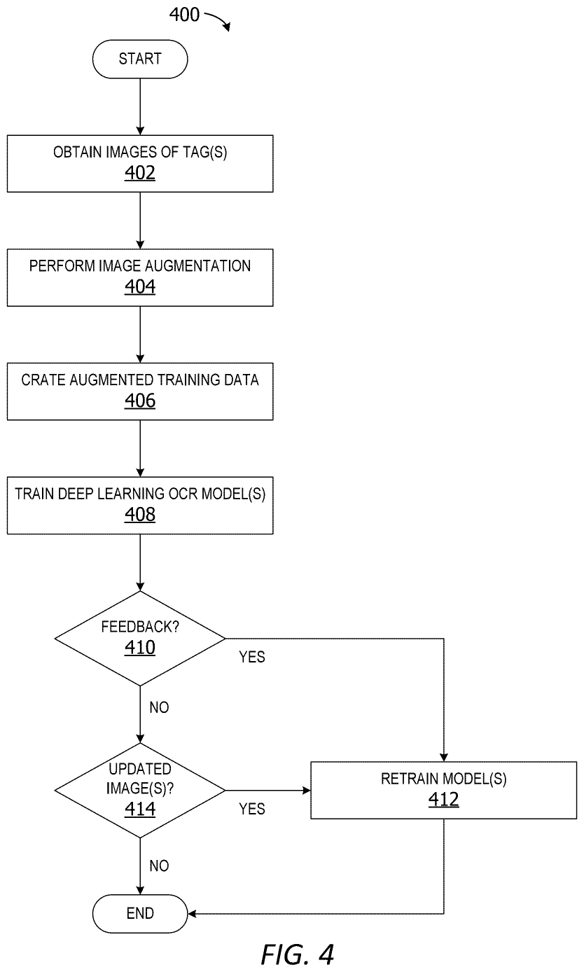

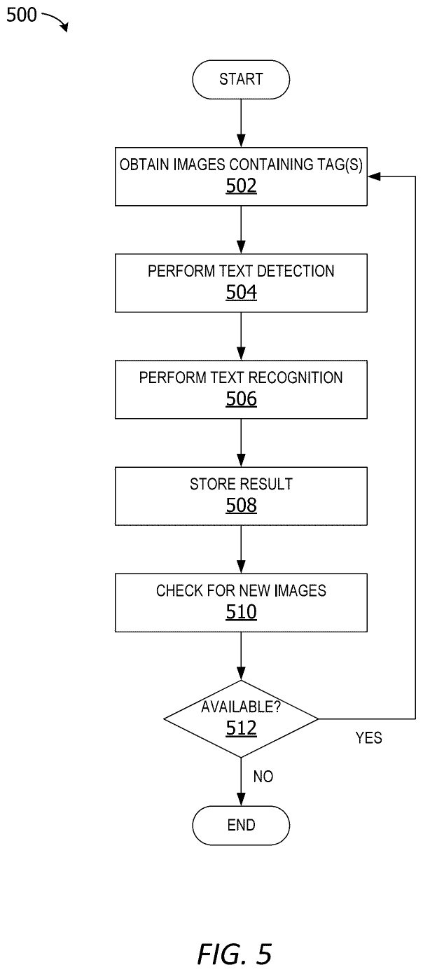

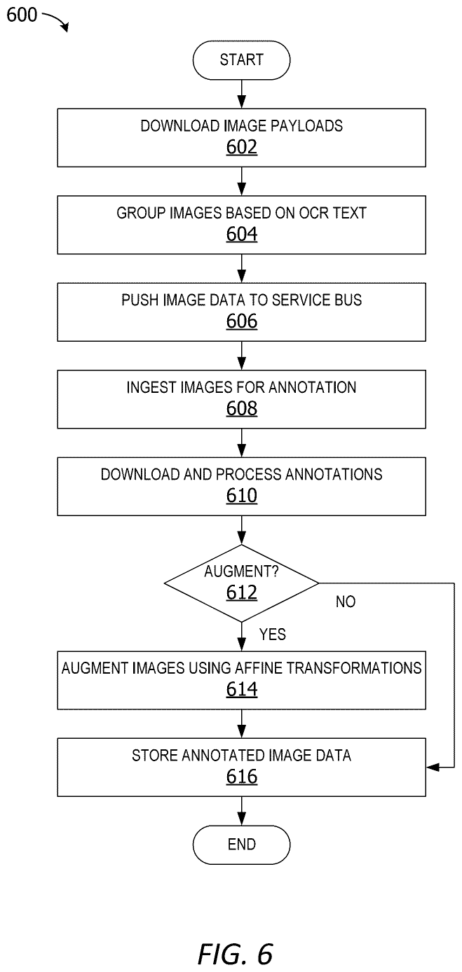

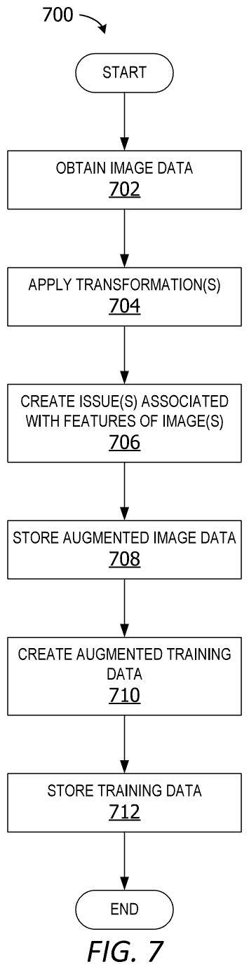

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 4, FIG. 5, FIG. 6, and/or FIG. 7).

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface device 110 includes a graphics card for displaying data to the user and receiving data from the user. The user interface device 110 can also include computer-executable instructions (e.g., a driver) for operating the graphics card. Further, the user interface device 110 can include a display (e.g., a touch screen display or natural user interface) and/or computer-executable instructions (e.g., a driver) for operating the display. The user interface device 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions (e.g., a driver) for operating the network interface card. Communication between the computing device 102 and other devices, such as but not limited to a user device 116, a cloud server 118, and/or one or more image capture device(s) 130, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface (UI) 122.

The UI 122 is a user interface device, such as, but not limited to, the user interface device 110. The UI 122 receives data input by a user and/or output data to the user. In some examples, the UI presents one or more text detection and/or text recognition result(s) 124. The results can include text associated with item description and/or item price. The item description can include a brand name, product name, size, variety information, or any other item description data.

The UI 122 can also be used to receive data input by a user. In some embodiments, a user provides one or more annotation(s) 126 for one or more of the image(s) 128 generated by one or more image capture device(s) 130. The annotation(s) 126 are provided manually in this example. However, in other examples, the annotation(s) 126 can be provided automatically by a software component. The annotation(s) 126 include a label identifying an object of interest appearing in an image and/or a cropped image. The annotation(s) 126 in other embodiments include bounding boxes around text in the images. The bounding boxes identify the location of text in the image. The bounding boxes surround the text appearing in one region of the image. An image can be annotated with a single bounding box enclosing a single region containing text or multiple bounding boxes enclosing two or more regions in the image containing text.

The cloud server 118 is a logical server providing services to the computing device 102 or other clients, such as, but not limited to, the user device 1xx. The cloud server 118 is hosted and/or delivered via the network 112. In some non-limiting examples, the cloud server 118 is associated with one or more physical servers in one or more data centers. In other examples, the cloud server 118 is associated with a distributed network of servers.

In this example, one or more deep learning OCR model(s) 132 are implemented on the cloud server 118. The deep learning OCR model(s) 132 include one or more deep learning text detection models for detecting text in image(s) 128 and/or one or more deep learning text recognition models for recognizing text in the image(s) 128. Text detection refers to detecting text appearing in an image. Recognizing text refers to reading or extracting the text from the image(s) 128.

The one or more image capture device(s) 130 includes any type of image capture device for generating the image(s) 128. The image(s) 128 can include black-and-white images and/or color images. In this example, the image(s) are digital images. The image capture device(s) 130 can include digital cameras, infrared cameras, or any other type of image capture devices. In this example, the image capture device(s) 130 include digital cameras mounted to one or more mobile robotic devices.

The system 100 can optionally include a data storage device 134 for storing data, such as, but not limited to augmented training data 136, image feature(s) 138, and/or tag types 142. The augmented training data 136 is training data generated by an image augmentation manager 140. The augmented training data 136 includes augmented image data 144. The augmented image data 144 includes image(s) 128 augmented to create one or more issue(s) 146 associated with one or more image feature(s) 138. An image feature in the one or more image feature(s) 138 include features such as lighting, focus, resolution, orientation, angle, out-of-focus camera, etc. The issue(s) 146 include one or more image quality issues, such as, but not limited to, decreased lighting, blurring, glare, crooked angle for text, upside down text, obscured text, etc.

Tag types 142 include tags having different layout 148, size 150 of tag, font 152 used in tag, color 154 of tag, etc. The layout 148 refers to layout of text on the tag. For example, the price may be on the right side, the left side, the middle of the tag, etc. The font 152 refers to the style of lettering associated with a given typeface. The typeface includes a type of font 152, the size of the font, the color of the font, etc.

The data storage device 134 can include one or more different types of data storage devices, such as, for example, one or more rotating disks drives, one or more solid state drives (SSDs), and/or any other type of data storage device. The data storage device 134 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 134 includes a database.

The data storage device 134 in this example is included within the computing device 102, attached to the computing device, plugged into the computing device, or otherwise associated with the computing device 102. In other examples, the data storage device 134 includes a remote data storage accessed by the computing device via the network 112, such as a remote data storage device, a data storage in a remote data center, or a cloud storage.

The memory 108 in some examples stores one or more computer-executable components, such as, but not limited to, the image augmentation manager 140. The image augmentation manager 140, when executed by the processor 106 of the computing device 102, obtains a plurality of images captured by the image capture device(s) 130 via the network 112. The image augmentation manager 140 performs image augmentation on the image(s) 128 to create one or more image quality issue(s) 146 which reduces readability of the text by the one or more deep learning OCR model(s). The augmented image(s) 120 include one or more image feature(s) 138 modified to create the issue(s) in the augmented image(s) 120. The image augmentation manager 140 creates the augmented training data 136 using the augmented image(s) 120. The augmented image(s) 120 include annotation(s) 126 used to train the model(s). The augmented image(s) 120 include images representing a plurality of different tag types 142 and a plurality of different typefaces. The different typefaces include different font types, font sizes, font colors, etc.

In some embodiments, the image augmentation manager 140 trains or initiates training of a set of one or more deep learning OCR model(s) using the augmented training data 136. The set of deep learning OCR models, in this example, includes a text detection model for detecting text associated with the plurality of different tag types and a text recognition model recognizing text appearing in the plurality of different typefaces. A trained set of deep learning OCR models are utilized to identify and extract an item-related data from a plurality of different types of tags in real-time with greater accuracy.

In some embodiments, the trained deep learning OCR models are used to detect text in images and place a bounding box around the regions of the images containing text. The trained deep learning OCR recognition models are used to extract data from the text by “reading” the text. The information extracted from the tag images are used to accurately identify items appearing in the images and/or items stored on the item storage structures appearing in the images, identify a location of the items described by the text on the tags, update inventory, re-stock shelves, order additional inventory, etc.

In some embodiments, the deep learning OCR models include a text detection model utilizing an architecture specifically designed for detecting text in images. This architecture is optimized to handle the complexities and variations present in price tag images. In other embodiments, the deep learning OCR models include a text recognition model based on a convolutional recurrent neural network (CRNN), a robust architecture for sequence recognition tasks. By employing CRNN, the text recognition model effectively recognizes and deciphers the textual content extracted by the detection model. The models are custom-trained for predicting text from price tags. This specialization improves the specificity of predictions, leading to more accurate and reliable results tailored to the unique characteristics of price tags in stores.

During training, in some embodiments, the image augmentation manager incorporates various augmentations such as flipping, affine transformation, resizing, and Gaussian blur. These augmentations enhance the model's ability to handle blurry and low-resolution images commonly encountered in real-world scenarios, ensuring better performance under diverse conditions. Through rigorous training and optimization, the deep learning OCR models achieve commendable accuracy in text extraction from price tags. This high accuracy not only ensures the reliability of the extracted information but also contributes to improved efficiency and effectiveness in various applications such as inventory management and automatic labeling. This enables a fast, light weight and highly scalable architecture for more accurate and reliable price tag text detection and recognition with automatic labeling of images.

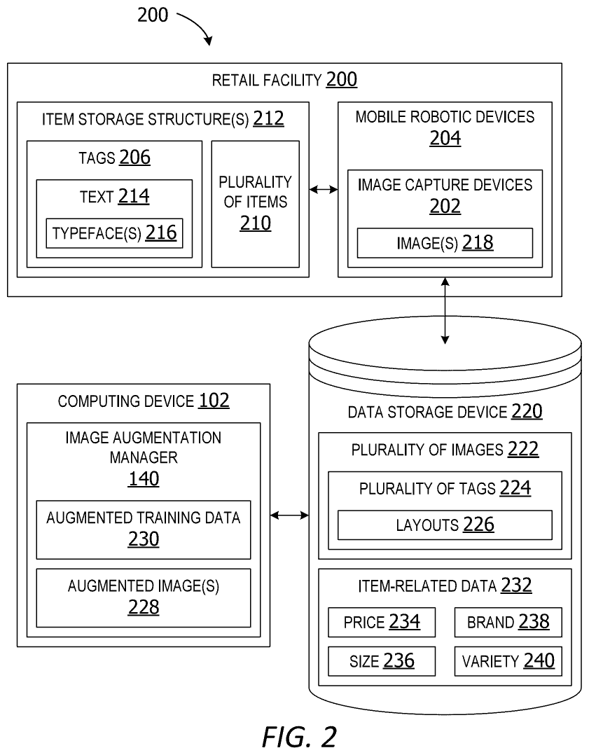

FIG. 2 is an exemplary block diagram illustrating a retail facility 200 including a plurality of image capture devices 202 associated with one or more mobile robotic devices 204 for generating images of tags 206. The retail facility 200 is any type of brick-and-mortar facility for storing a plurality of items 210, such as, but not limited to, a store, warehouse, distribution center (DC), fulfillment center, etc. The retail facility 200 includes one or more item storage structure(s) 212 for storing one or more items in the plurality of items 210. The item storage structure(s) 212 can include shelving, bins, temperature-controlled displays, end-cap displays, gondola shelves, pallet storage structures, or any other type of structure for supporting, displaying or storing items.

The plurality of items 210 includes any type of item, such as individual items, cases of items, pallets of items, etc. The items can include food items, pet supply items, hardware, electronics, housewares, apparel items, or any other type of items.

Each item storage structure includes one or more tags 206. Each tag includes text 214 in one or more typeface(s) 216. Image(s) 218 of the tags 206 are captured by the image capture devices 202 mounted to one or more mobile robotic devices 204. The mobile robotic devices 204 roam around an interior and/or an exterior of the retail facility 200 to capture the image(s) 218 of the tags 206 on the one or more item storage structure(s) 212.

The image(s) 218 are stored with a plurality of images 222 of a plurality of tags 224 having a plurality of different layouts 226 and/or typeface(s) 216. The images are stored in a data storage device 220 in this example. The data storage device 220 is a device, such as, but not limited to, the data storage device 134 in FIG. 1.

The image augmentation manager 140 on the computing device 102, in this example, utilizes the plurality of images 222 to create augmented image(s) 228 which are used to create augmented training data 230. The augmented training data 230 is used to train deep learning OCR models to extract item-related data 232 from the text 214 detected within images of tags captured by the image capture devices in the future. The item-related data 232 includes any type of data describing the plurality of items 210 which is included in the text on the tags attached to a portion of the item storage structure(s) 212. The item-related data 232, in some embodiments, includes a price 234, size 236 of the item, brand 238, variety 240, and/or any other information. The price 234 can include one or more prices associated with one or more items. The size 236 can include the size of the product packaging, weight of the product, volume of a container, etc. The brand 238 refers to the name of the product and/or brand name of the producer of the item. The variety 240 refers to the variety of the item. For example, a bottle of ketchup can come in varieties, such as, but not limited to, organic varieties, sugar-free varieties, reduced sugar varieties, spicy varieties, etc.

In some embodiments, the information on a tag can include item-description data such as, but not limited to, a brand name, generic product name, product number, universal product code (UPC), unit price, store number, product category name, category number, sub-category name, sub-category number, as well as any other item information. For example, a tag might include information such as “Brand A Ultra Healing Lotion 2 pk/2.1 oz. $12.98”. In this example, the item description includes the brand, item description, product size, and price. The item name, number, UPC or other information can be used to cross reference a product catalog or other database of item information to obtain additional information about the items and/or item location.

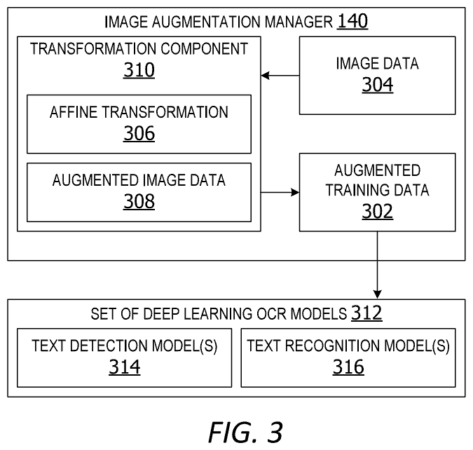

FIG. 3 is an exemplary block diagram illustrating an image augmentation manager 140 for generating augmented training data 302 and training deep learning OCR models. In some embodiments, the image augmentation manager 140 obtains image data 304 associated with images generated by one or more image capture devices, such as, but not limited to, the image capture device(s) 130 in FIG. 1 and/or the image capture devices 202 in FIG. 2. A transformation component 310 performs one or more transformations on the image data 304, such as, but not limited to, an affine transformation 306, to create augmented image data 308. The augmented image data 308 includes a modification to the original image to create an issue associated with at least one feature of the image to decrease readability of the text in the images. The augmented image data 308 is used to create augmented training data 302.

A set of one or more deep learning models 312 are trained using the augmented training data 302. Each deep learning model in the set of deep learning models is a computer vision (CV) image recognition as a service (IRAS) deep learning model. The set of deep learning OCR models 312 includes one or more text detection model(s) 314 for detecting text within an image and/or one or more text recognition model 316 for recognizing detected text.

The text detection model(s) 314 include a neural network that does performs an image segmentation to isolate one object in image. The image segmentation is used to identify only the relevant items in the image, such as an object of interest. In this example, the object of interest is the region containing text. The model segments only the text areas in the price tag image. In some embodiments, the text detection model uses differentiable binarization to segment out only the text part. The output from this model includes the highlighted textual regions of the image enclosed in a bounding box or otherwise annotated to identify the text regions once the textual regions are identified.

The text recognition model 316 in some embodiments takes input of these textual regions and outputs the actual text present. This model is another neural network that uses CRNN to identify text features present in the highlighted text region identified by the text detection model. It identifies the exact text that is present in each textual region enclosed in a bounding box or otherwise identified by the text detection model.

Turning now to FIG. 4, an exemplary flow chart illustrating operation of the computing device to train deep learning OCR models for detection and recognition of text where image quality is suboptimal is shown. The process 400 shown in FIG. 4 is performed by a customized returns manager component, executing on a computing device, such as the computing device 102 or the user device 116 in FIG. 1.

The process begins by obtaining images of tag(s) at 402. The images are generated by one or more image capture devices, such as, but not limited to, the image capture device(s) 130 in FIG. 1 and/or the image capture devices 202 in FIG. 2. Image augmentation is performed by the image augmentation manager at 404. Augmented training data is created at 406. Deep learning OCR model(s) are trained at 408. The deep learning OCR model(s) include one or more object detection and recognition models, such as, but not limited to, the deep learning OCR model(s) 132 in FIG. 1 and/or the set of deep learning OCR models 312 in FIG. 3. A determination is made whether feedback is received at 410. The feedback is feedback associated with performance of the trained deep learning OCR models. The feedback is provided via a UI, such as, but not limited to, the user interface device 110 and/or the UI 122 in FIG. 2. If feedback is received at 410, the model(s) are retrained using the feedback at 412. The process terminates thereafter.

A determination is made whether updated image(s) are received at 414. The image(s) are digital images of tags, such as, but not limited to, the image(s) 128 in FIG. 1 and the image(s) 218 in FIG. 2. If updated image(s) are received at 414, the model(s) are retrained at 412. The process terminates thereafter.

While the operations illustrated in FIG. 4 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 4.

FIG. 5 is an exemplary flow chart illustrating operation of the computing device to detect and recognize text associated with a variety of tag types and typefaces. The process 500 shown in FIG. 5 is performed by a customized returns manager component, executing on a computing device, such as the computing device 102 or the user device 116 in FIG. 1.

The process begins by obtaining images containing tag(s) at 502. The images can be retrieved from a data storage device or received directly from an image capture device. Text detection is performed at 504. The text detection is performed by a text detection model, such as, but not limited to, the text detection model(s) 314 in FIG. 3. Text recognition is performed at 506. The text recognition is performed by a trained model, such as, but not limited to, the text recognition model(s) 316. The result of the text detection and text recognition is stored at 508. The results can be stored in a data storage, such as, but not limited to, the data storage device 134 in FIG. 1 and/or the data storage device 220 in FIG. 2. The image augmentation manager checks for new images at 510. The new images are images including a tag or portion of a tag generated by an image capture device. A determination is made whether new images are available at 512. If yes, the process iteratively executes operations 502 through 512 until no new images are available at 512. The process terminates thereafter.

While the operations illustrated in FIG. 5 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 5.

FIG. 6 is an exemplary flow chart illustrating operation of the computing device to obtain and annotate image data for use in training data. The process 600 shown in FIG. 6 is performed by a customized returns manager component, executing on a computing device, such as the computing device 102 or the user device 116 in FIG. 1.

The process begins by downloading an image payload at 602. The image payloads are downloaded from a data storage device and/or image capture devices. In some embodiments, the image payload is obtained from a cloud storage associated with a cloud platform. Images are grouped based on OCR text at 604. The image data is pushed to a service bus at 606. Images are ingested for annotation at 608. The image augmentation manager downloads and processes annotations at 610. The annotations include labels identifying objects in the images, such as, but not limited to, the annotation(s) 126 in FIG. 1. A determination is made whether to augment the images at 612. If not, the process terminates thereafter.

Returning to 612, if a determination is made to augment the images, affine transformations are used to augment the images at 614. The annotated image data is stored at 616. The process terminates thereafter.

While the operations illustrated in FIG. 6 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 6.

FIG. 7 is an exemplary flow chart illustrating operation of the computing device to perform image transformations creating image quality issues associated with one or more features of an image. The process 700 shown in FIG. 7 is performed by a customized returns manager component, executing on a computing device, such as the computing device 102 or the user device 116 in FIG. 1.

The process begins by obtaining image data at 702. The image data is data associated with images of tags, such as, but not limited to, the image data 144 in FIG. 1 and/or the image data 304 in FIG. 3. Transformation(s) are applied to the image data at 704. The transformation(s) are applied to artificially create issues negatively impacting readability of text in the images, such as blurriness. Image quality issue(s) associated with features of the image(s) are created at 706. The augmented image data is stored at 708. Augmented training data is created at 710. The augmented training data is created using the augmented image data. The augmented training data is stored at 712. The data is stored in a storage device, such as, but not limited to, the data storage device 134 in FIG. 1 and/or the data storage device 220 in FIG. 2.

While the operations illustrated in FIG. 7 are performed by a computing device, aspects of the disclosure contemplate performance of the operations by other entities. In a non-limiting example, a cloud service performs one or more of the operations. In another example, one or more computer-readable storage media storing computer-readable instructions may execute to cause at least one processor to implement the operations illustrated in FIG. 7.

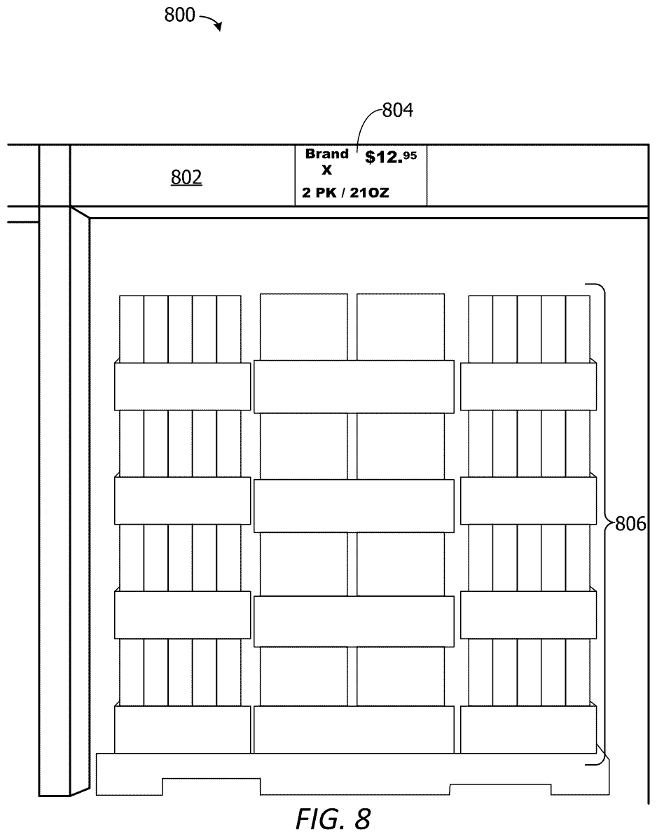

Referring now to FIG. 8, an exemplary diagram illustrating an image 800 of a tag 804 on a portion of an item storage structure is shown. In this example, the tag 804 is attached to a portion of a vertical steel bar 802 of the item storage structure containing a plurality of items 806 on the item storage structure. In some embodiments, the system extracts the price tag information from the tags that are attached on the horizontal steel bars on the item storage structures. The system maps the price tag along with the items below it that are detected. Through this item to price tag mapping and the information extracted from the price tag, inventory can be updated in real-time.

In this example, the tag is attached to a horizontal steel bar. However, the embodiments are not limited to tag placement on a horizontal steel bar. In other embodiments, the tag is removably attached to a horizontal member of the item storage structure, a shelf edge, or any other portion of the item storage structure.

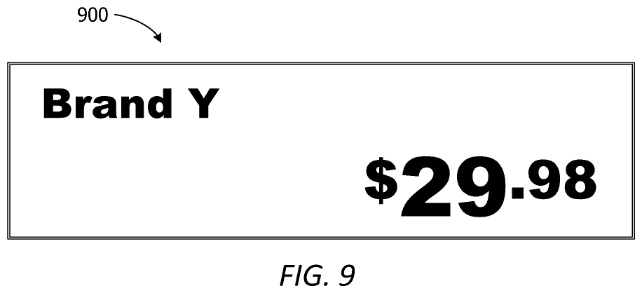

FIG. 9 is an exemplary diagram illustrating a tag 900 having item-related data in a text format. In this example, the tag 900 includes a name of an item and a price of the item printed on the tag in printed text on a paper tag. However, the embodiments are not limited to identifying and reading printed text on a paper tag. In other embodiments, the text is digital text on a digital tag.

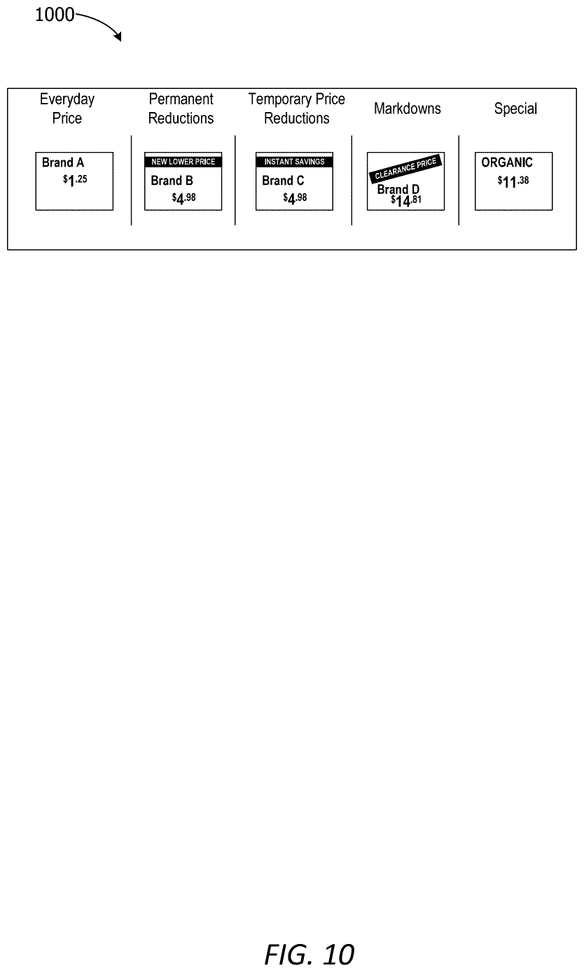

FIG. 10 is an exemplary diagram illustrating a plurality of different types of tags 1000 having a plurality of different typefaces. Tags, such as price tags, come in a variety of different sizes, shapes, and layouts. In this example, different types of tags are shown for everyday price tags, permanent reduction price tags, temporary price reduction price tags, and markdown price tags. However, the embodiments are not limited to the types of tags shown in FIG. 10.

In this example, the layouts of the tags can include text in different locations, different sizes of lettering, and other inconsistencies between types of tags. The layout refers to the arrangement of text on the tag. The text in different types of tags can likewise have a variety of different typefaces including different types of lettering, different sizes of lettering, different colors of the lettering, etc. The text can include a mix of printed text and handwritten marking on the tag. The deep learning OCR models are trained using the augmented training data to enable the models to detect and recognize a wide variety of text typefaces appearing in different layouts on different types of tags appearing in images having quality issues associated with one or more features of the images, such as in edge cases in which images are captured that have poor lighting, glare on the images, blurring, angled text, or other image quality issues.

### ADDITIONAL EXAMPLES

In some examples, the system enables IRAS price tag OCR image detection and recognition. The trained deep learning OCR models are able to predict issues in image quality of the images, such as, but not limited to, blurriness or other issues resulting in difficulty accurately recognizing text. The trained deep learning OCR models have a lightweight architecture, and are capable of faster and more accurate text detection and recognition, as well as being scalable. The system further automates the process of labeling images of price tags.

In some embodiments, the system artificially induces issues in features of image quality to cause blurriness, glare, angled images, obscured images, or other issues. These modified images are used to train the models so that the models are more familiar with images that have blurring, glare, other augmentations like flipping the image, angled images, and any kind of affine transformations. The augmentations make the images of the price tags distorted or otherwise include issues resulting in poor image quality. The trained models are able to make accurate text detection and recognition predictions when these issues are present in unannotated non-training images, thereby improving model performance.

In some embodiments, millions of images can be generated every day. The images can include tags for thousands of different products which can include new products added to product assortments every day. The processing of annotating these images would be cost prohibitive. The system, in some embodiments, uses the price tag information extractor to automate this process of annotating (labeling) the images. In these examples, the system performs price tag detection and price tag recognition to identify the contents of images and label the images automatically with labels generated based on the text appearing in price tags within the images. In other words, the system detects and reads text on price tags in images in order to accurately label products appearing in the images without human intervention. This price tag text recognition utilized for OCR-based automatic labeling of item image templates reduces labeling effort by automating the process which further enhances the efficiency of labelling while reducing costs.

In other embodiments, the system employs domain specific preprocessing to filter out noise in the images. Post processing steps are employed to understand the recognitions in context, for example, correcting for common OCR errors (e.g., mistaking “1” for “l” or “0” for “O”), recognizing currency symbols and/or format inconsistencies (e.g., “$”). The system must be capable of accurately extracting text information from a wide variety of price tag types found in stores.

In still other embodiments, the system includes a pipeline to download scrubber images, categorize them based on OCR text from price tags, and create a stratified sample dataset annotated with price tag bounding boxes, text regions, and text using an image annotation platform. The models are trained to locate the text area in the images. A text detector based on a segmentation network that uses differentiable binarization more accurately detect text regions in edge cases in which images include blurring, poor lighting, low-resolution, angled text, obstructions, or other issues negatively impacting image quality.

The text recognition model, in some embodiments, includes a CRNN based text recognizer that integrates feature extraction and sequence modeling. It uses connectionist temporal classification (CTC) loss to avoid the inconsistency between predictions made by the models. Improved item recognition leads to accurate item location mapping and thus better inventory management.

In some embodiments, the system accurately extracts text information from a variety of price tag types, for example, locate text area in image using IRAS price tag optical character recognition (OCR). The system utilizes a detection model which utilizes a Differentiable Binarization (DBnet) architecture designed for detecting text in images. The architecture is optimized to handle complexities and variations present in price tag images. The detection model is based on a segmentation network which uses differentiable binarization. The system utilizes a recognition model based on CRNN. The model effectively recognizes and deciphers the textual content extracted by the detection model. The model integrates feature extraction and sequence modelling tasks. The system utilizes connectionist temporal classification loss to avoid inconsistency between the prediction and the label. The system utilizes augmentation techniques to enhance the model's ability to handle blurry and low-resolution images commonly encountered in real-world scenarios, for example ensuring better performance under diverse conditions. The augmentation techniques include flipping, affine transformation, resizing, and/or Gaussian blur.

Alternatively, or in addition to the other examples described herein, examples include any combination of the following:
perform a set of transformations on a subset of images in the plurality of images to create an image quality issue associated with at least one feature of each image, the set of transformations comprising at least one of decreasing resolution of an image or blurring at least a portion of the image;
perform a set of transformations on a set of images in the plurality of images, the set of transformations comprising obscuring a portion of an image in the set of images;
perform a set of transformations on a set of images in the plurality of images, the performing the set of transformations comprises altering an orientation of text in each image, wherein altering an orientation of the text comprises rotating the text in the image to change an angle of the text appearing in the image or changes a degree of rotation of the text appearing in the image;
perform a set of transformations on a set of images in the plurality of images, the performing the set of transformations comprises changing a lighting level associated with an image to darken at least a portion of the image.
wherein the text recognition model is based on a convolutional recurrent neural network (CRNN), a robust architecture for sequence recognition tasks enabling the text recognition model to accurately recognize and decipher content extracted by the text detection model;
identify each item in a set of items associated with at least one tag in an image of a tag analyzed using a result of text detection and recognition performed on the image by the trained set of deep learning OCR models;
perform affine transformations on the plurality of images to create images with text which are angled, rotated, and off-center within each image;
create at least one image having low-resolution text, the low-resolution text including text that is blurred;
wherein the at least one feature comprises at least one of an amount of lighting associated with an image, an angle text appearing in the image, degree of rotation of the text appearing in the image, and focus of a text region of the image;
the augmented training data further comprises a stratified data set of annotated images, wherein the stratified data set of annotated images comprises a first set of annotated tag images associated with a first type of tag having a first tag layout, a second set of annotated tag images associated with a second type of tag having a second tag layout, and a third set of annotated tag images associated with a third type of tag having a third tag layout;
obtaining, from an image capture device, a plurality of images of a tag associated with a portion of an item storage structure via a network;
performing image augmentation on each image in the plurality of images reducing readability of text by an optical character recognition (OCR) deep learning (ML) model, wherein the image augmentation comprises changing at least one feature of each image;
creating augmented training data comprising a plurality of augmented images representing a plurality of different tag types and a plurality of different typefaces;
training a set of deep learning OCR models using the augmented training data, the set of deep learning OCR models comprising a text detection model for detecting text associated with the plurality of different tag types and a text recognition model recognizing text appearing in the plurality of different typefaces;
identifying, via a trained set of deep learning OCR models, text associated having a readability issue appearing within images in real-time with greater accuracy, wherein identifying the text comprises detecting the text by the text detection model and recognizing the text by the text recognition model; and
wherein a trained set of deep learning OCR models are utilized to identify and extract an item-related data from a plurality of different types of tags in real-time with greater accuracy.

At least a portion of the functionality of the various elements in FIG. 1, FIG. 2, and FIG. 3 can be performed by other elements in FIG. 1, FIG. 2, and FIG. 3, or an entity (e.g., processor 106, web service, server, application program, computing device, etc.) not shown in FIG. 1, FIG. 2, and FIG. 3.

In some examples, the operations illustrated in FIG. 4, FIG. 5, FIG. 6, and FIG. 7 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

In other examples, a computer readable medium having instructions recorded thereon which when executed by a computer device cause the computer device to cooperate in performing a method of training deep learning OCR detection and recognition models using augmented training data, the method comprising obtaining, from an image capture device, a plurality of images of a tag associated with a portion of an item storage structure via a network; performing image augmentation on each image in the plurality of images reducing readability of text by an optical character recognition (OCR) deep learning (ML) model, wherein the image augmentation comprises changing at least one feature of each image; creating augmented training data comprising a plurality of augmented images representing a plurality of different tag types and a plurality of different typefaces; training a set of deep learning OCR models using the augmented training data, the set of deep learning OCR models comprising a text detection model for detecting text associated with the plurality of different tag types and a text recognition model recognizing text appearing in the plurality of different typefaces; and identifying, via a trained set of deep learning OCR models, text associated having a readability issue appearing within images in real-time with greater accuracy, wherein identifying the text comprises detecting the text by the text detection model and recognizing the text by the text recognition model.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for augmented image recognition of multi-type item tags. For example, the elements illustrated in FIG. 1, FIG. 2, and FIG. 3, such as when encoded to perform the operations illustrated in FIG. 4, FIG. 5, FIG. 6, and FIG. 7, constitute exemplary means for obtaining, from an image capture device, a plurality of images of a tag associated with a portion of an item storage structure via a network; exemplary means for performing image augmentation on each image in the plurality of images reducing readability of text by an optical character recognition (OCR) deep learning (ML) model, wherein the image augmentation comprises changing at least one feature of each image; exemplary means for creating augmented training data comprising a plurality of augmented images representing a plurality of different tag types and a plurality of different typefaces; exemplary means for training a set of deep learning OCR models using the augmented training data, the set of deep learning OCR models comprising a text detection model for detecting text associated with the plurality of different tag types and a text recognition model recognizing text appearing in the plurality of different typefaces; and exemplary means for identifying, via a trained set of deep learning OCR models, text associated having a readability issue appearing within images in real-time with greater accuracy, wherein identifying the text comprises detecting the text by the text detection model and recognizing the text by the text recognition model.

Other non-limiting examples provide one or more computer storage devices having a first computer-executable instructions stored thereon for providing augmenting image data associated with multi-type item tags. When executed by a computer, the computer performs operations including obtaining, from an image capture device, a plurality of images of a tag associated with a portion of an item storage structure via a network; performing image augmentation on each image in the plurality of images reducing readability of text by an optical character recognition (OCR) deep learning (ML) model, wherein the image augmentation comprises changing at least one feature of each image; creating augmented training data comprising a plurality of augmented images representing a plurality of different tag types and a plurality of different typefaces; training a set of deep learning OCR models using the augmented training data, the set of deep learning OCR models comprising a text detection model for detecting text associated with the plurality of different tag types and a text recognition model recognizing text appearing in the plurality of different typefaces; and identifying, via a trained set of deep learning OCR models, text associated having a readability issue appearing within images in real-time with greater accuracy, wherein identifying the text comprises detecting the text by the text detection model and recognizing the text by the text recognition model.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of′ ”only one of′ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for augmenting image data associated with multi-type item tags, the system comprising:
an item storage structure associated with a plurality of items;
a robotic device having an image capture device mounted thereon, the image capture device generating a plurality of images of a set of tags associated with at least a portion of the item storage structure, a portion of each item tag in the set of tags comprising text describing the plurality of items; and
a computer-readable medium storing instructions that are operative upon execution by a processor to:
obtain the plurality of images captured by the image capture device via a network;
perform image augmentation on each image in the plurality of images reducing readability of the text by an optical character recognition (OCR) deep learning (ML) model, wherein the image augmentation comprises changing a feature of each image;
create augmented training data comprising a plurality of augmented images representing a plurality of different tag types and a plurality of different typefaces; and
train a set of deep learning OCR models using the augmented training data, the set of deep learning OCR models comprising a text detection model for detecting text associated with the plurality of different tag types and a text recognition model recognizing text appearing in the plurality of different typefaces, wherein a trained set of deep learning OCR models are utilized to identify and extract an item-related data from a plurality of different types of tags in real-time with greater accuracy.

2. The system of claim 1, wherein the instructions are further operative to:
perform a set of transformations on a subset of images in the plurality of images to create an image quality issue associated with at least one feature of each image, the set of transformations comprising at least one of decreasing resolution of an image or blurring at least a portion of the image.

3. The system of claim 1, wherein the instructions are further operative to:
perform a set of transformations on a set of images in the plurality of images, the set of transformations comprising obscuring a portion of an image in the set of images.

4. The system of claim 1, wherein the instructions are further operative to:
perform a set of transformations on a set of images in the plurality of images, wherein performing the set of transformations comprises altering an orientation of text in each image, wherein altering an orientation of the text comprises at least one of rotating the text in each image to change an angle of the text appearing in each image.

5. The system of claim 1, wherein the instructions are further operative to:
perform a set of transformations on a set of images in the plurality of images, wherein performing the set of transformations comprises changing a lighting level associated with an image to darken at least a portion of the image.

6. The system of claim 1, wherein the instructions are further operative to:
identify each item in a set of items associated with at least one tag in an image of a tag analyzed using a result of text detection and recognition performed on the image by the trained set of deep learning OCR models.

7. The system of claim 1, wherein the augmented training data further comprises a stratified data set of annotated images, wherein the stratified data set of annotated images comprises a first set of annotated tag images associated with a first type of tag having a first tag layout, a second set of annotated tag images associated with a second type of tag having a second tag layout, and a third set of annotated tag images associated with a third type of tag having a third tag layout.

8. A method for augmenting image data associated with multi-type item tags, the method comprising:
obtaining, from an image capture device, a plurality of images of a tag associated with a portion of an item storage structure via a network;
performing image augmentation on each image in the plurality of images reducing readability of text by an optical character recognition (OCR) deep learning (ML) model, wherein the image augmentation comprises changing a feature of each image;
creating augmented training data comprising a plurality of augmented images representing a plurality of different tag types and a plurality of different typefaces;
training a set of deep learning OCR models using the augmented training data, the set of deep learning OCR models comprising a text detection model for detecting text associated with the plurality of different tag types and a text recognition model recognizing text appearing in the plurality of different typefaces; and
identifying, via a trained set of deep learning OCR models, text associated having a readability issue appearing within images in real-time with greater accuracy, wherein identifying the text comprises detecting the text by the text detection model and recognizing the text by the text recognition model.

9. The method of claim 8, further comprising:
performing a set of transformations on a subset of images in the plurality of images to create an image quality issue associated with at least one feature of each image, the set of transformations comprising decreasing resolution of an image.

10. The method of claim 8, further comprising:
performing a set of transformations on a set of images in the plurality of images, the set of transformations comprising blurring a portion of each image in the set of images.

11. The method of claim 8, further comprising:
performing affine transformations on the plurality of images to create images with text which are angled, rotated, and off-center within each image.

12. The method of claim 8, further comprising:
decreasing image resolution of at least one image in the plurality of images.

13. The method of claim 8, wherein the augmented training data further comprises a stratified data set of annotated images, wherein the stratified data set of annotated images comprises a first set of annotated tag images associated with a first type of tag having a first tag layout, a second set of annotated tag images associated with a second type of tag having a second tag layout, and a third set of annotated tag images associated with a third type of tag having a third tag layout.

14. The method of claim 8, wherein the feature comprises at least one of an amount of lighting associated with an image, an angle text appearing in the image, degree of rotation of the text appearing in the image, and focus of a text region of the image.

15. One or more computer storage devices having computer-executable instructions stored thereon, which, upon execution by a computer, cause the computer to perform operations comprising:
obtaining, from an image capture device mounted on a mobile robotic device, a plurality of images of a tag associated with a portion of an item storage structure via a network;
performing image augmentation on each image in the plurality of images reducing readability of printed text by an optical character recognition (OCR) deep learning (ML) model, wherein the image augmentation comprises changing a feature of each image;
creating augmented training data comprising a plurality of augmented images representing a plurality of different tag types and a plurality of different typefaces;
training a set of deep learning OCR models using the augmented training data, the set of deep learning OCR models comprising a text detection model for detecting text associated with the plurality of different tag types and a text recognition model recognizing text appearing in the plurality of different typefaces; and
identifying, via a trained set of deep learning OCR models, text associated having a readability issue appearing within images in real-time with greater accuracy, wherein identifying the text comprises detecting the text by the text detection model and recognizing the text by the text recognition model.

16. The one or more computer storage devices of claim 15, wherein the text recognition model is based on a convolutional recurrent neural network (CRNN), a robust architecture for sequence recognition tasks enabling the text recognition model to accurately recognize and decipher content extracted by the text detection model.

17. The one or more computer storage devices of claim 15, wherein the operations further comprise:
identifying each item in a set of items associated with at least one tag in an image of a tag analyzed using a result of text detection and recognition performed on the image by the trained set of deep learning OCR models.

18. The one or more computer storage devices of claim 15, wherein the operations further comprise:
performing affine transformations on the plurality of images to create images with text which are angled, rotated, and off-center within each image.

19. The one or more computer storage devices of claim 15, wherein the operations further comprise:
creating at least one image having low-resolution text, the low-resolution text including text that is blurred.

20. The one or more computer storage devices of claim 15, wherein the augmented training data further comprises a stratified data set of annotated images, wherein the stratified data set of annotated images comprises a first set of annotated tag images associated with a first type of tag having a first tag layout, a second set of annotated tag images associated with a second type of tag having a second tag layout, and a third set of annotated tag images associated with a third type of tag having a third tag layout.
